(19) United States
(12) Patent Application Publication
(10) Pub. No.: US 2025/0029423 A1
(43) Pub. Date: Jan. 23, 2025

(54) ACTION EVALUATION SYSTEM, ACTION EVALUATION METHOD, AND NON-TRANSITORY COMPUTER READABLE MEDIUM

(71) Applicant: NEC Corporation, Minato-ku, Tokyo (JP)

(72) Inventors: Ryo KAWAI, Tokyo (JP); Noboru YOSHIDA, Tokyo (JP); Jianquan LIU, Tokyo (JP)

(21) Appl. No.: 18/711,934

(22) PCT Filed: Nov. 29, 2021
(86) PCT No.: PCT/JP2021/043619

§ 371 Date: May 21, 2024

(51) Int. Cl. G06V 40/20; G06Q 10/0639; G06T 7/246; G06V 10/62

(52) U.S. Cl. CPC G06V 40/23; G06Q 10/06398; G06T 7/248; G06V 10/62; G06T 2207/20044

(57) ABSTRACT

An action evaluation system includes at least one memory storing instructions, and at least one processor configured to execute the instructions to detect a predetermined unit action associated with a posture of a worker from skeleton data about a structure of a body of the worker extracted from image data obtained by capturing a series of work actions performed by the worker on a work object, determine whether or not the unit action is similar to a predetermined registration action and output a result of the determination.

### TECHNICAL FIELD

The present disclosure relates to an action evaluation system, an action evaluation method, and a non-transitory computer readable medium.

### BACKGROUND ART

In a process of inspecting finished industrial products such as automobiles, a single worker performs a plurality of inspection steps. Techniques for evaluating a series of work performed by a worker described above have been developed.

For example, the work analyzing device disclosed in Patent Literature 1 causes a processor to perform operations to output analytical information on a work efficiency status of a worker based on a video of working activities of the worker.

The motion-analyzing system disclosed in Patent Literature 2 measures motion information indicating a motion of one or more workers which has been performed in a certain work area, compares the motion information with a reference motion as a reference for comparison, and then extracts motion information that satisfies a predetermined condition.

### CITATION LIST

### Patent Literature

Patent Literature 1: International Patent Publication No. WO 2021/131552
Patent Literature 2: International Patent Publication No. WO 2019/138877

### SUMMARY OF INVENTION

### Technical Problem

However, there is a need for a system for more suitably evaluating whether or not work is properly performed in a process of performing a plurality of pieces of work by a single worker described above.

In view of the problem described above, an object of the present disclosure is to provide an action evaluation system and the like for suitably evaluating whether or not work to be performed by a worker is properly performed.

### Solution to Problem

An action evaluation system according to one example aspect of the present disclosure includes analysis means, determination means, and determination result output means. The analysis means detects a predetermined unit action associated with a posture of a worker from skeleton data about a structure of a body of the worker, the skeleton data being extracted from image data obtained by capturing a series of work actions performed by the worker on a work object. The determination means determines whether or not the unit action is similar to a predetermined registration action. The determination result output means outputs a result of the determination made by the determination means.

In an action evaluation method according to one example aspect of the present disclosure, a computer performs the following processing. The computer detects a predetermined unit action associated with a posture of a worker from skeleton data about a structure of a body of the worker extracted from image data obtained by capturing a series of work actions performed by the worker on a work object. The computer determines whether or not the unit action is similar to a predetermined registration action. Then the computer outputs a result of the above determination.

A non-transitory computer readable medium according to one example aspect of the present disclosure causes a computer to perform the following method. The computer detects a predetermined unit action associated with a posture of a worker from skeleton data about a structure of a body of the worker extracted from image data obtained by capturing a series of work actions performed by the worker on a work object. The computer determines whether or not the unit action is similar to a predetermined registration action. Then the computer outputs a result of the determination.

### Advantageous Effects of Invention

According to the present disclosure, it is possible to provide an action evaluation system and the like for suitably evaluating whether or not work to be performed by a worker is properly performed.

### BRIEF DESCRIPTION OF DRAWINGS

FIG. 1 is a block diagram showing a configuration of an action evaluation system according to a first example embodiment;

FIG. 2 is a flowchart showing an action evaluation method according to the first example embodiment:

FIG. 3 is a diagram showing an overall configuration of an action evaluation system according to a second example embodiment:

FIG. 4 is a flowchart showing an action evaluation method according to the second example embodiment:

FIG. 5 is a diagram showing an example of image data acquired by the action evaluation system:

FIG. 6 is a diagram showing skeleton data extracted from image data:

FIG. 7 is a table showing an example of registration actions stored by a storage unit according to the second example embodiment:

FIG. 8 is a diagram showing a first example of skeleton data of a registration action:

FIG. 9 is a diagram showing a second example of skeleton data of a registration action:

FIG. 10 is a diagram showing an example of a result of the determination output by the action evaluation system according to the second example embodiment:

FIG. 11 is a diagram showing an overall configuration of an action evaluation system according to a third example embodiment:

FIG. 12 is a block diagram showing a configuration of an action evaluation apparatus according to the third example embodiment:

FIG. 13 is a block diagram showing a configuration of a process control apparatus according to the third example embodiment:

FIG. 14 is a flowchart showing an action evaluation method according to the third example embodiment:

FIG. 15 is a table showing an example of work actions stored by the action evaluation system according to the third example embodiment; and

FIG. 16 is a flowchart showing processing for registering a registration action according to the third example embodiment.

### EXAMPLE EMBODIMENT

The present disclosure will be described hereinafter through example embodiments. However, the following example embodiments are not intended to limit the scope of the disclosure according to the claims. Further, all the components described in the example embodiments are not necessarily essential as means for solving the problem. The same elements are denoted by the same reference symbols throughout the drawings, and redundant descriptions are omitted as necessary.

### First Example Embodiment

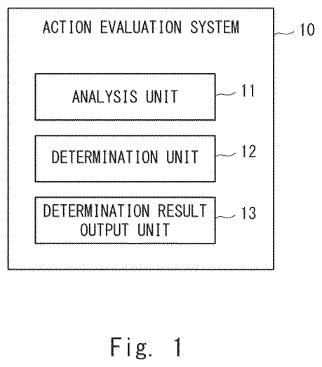

First, a first example embodiment of the present disclosure will be described. FIG. 1 is a block diagram showing a configuration of an action evaluation system according to the first example embodiment. An action evaluation system 10 shown in FIG. 1 is a system for evaluating a work action performed by a worker on a predetermined work object. The predetermined work object may include, for example, a transportation means such as an automobile, a motorcycle, a bicycle, a ship, and an airplane, and an industrial product such as a built-in kitchen, furniture, or various types of machinery. The work action is a predetermined work action performed on the aforementioned work object, and examples of the work include assembly work and inspection work. The action evaluation system 10 includes an analysis unit 11, a determination unit 12, and a determination result output unit 13.

The analysis unit 11 detects a predetermined unit action associated with a posture of a worker from skeleton data about the structure of the body of the worker. More specifically, when skeleton data about the structure of the body of the worker is similar to a predetermined unit action, the analysis unit 11 detects the skeleton data as a unit action.

The skeleton data is extracted from image data obtained by capturing a series of work actions performed by the worker on a work object. The skeleton data is data showing the structure of the body of the worker for detecting the posture or the action of the worker, and is composed of a combination of a plurality of pseudo joint points and pseudo skeleton structures. The image data for extracting the skeleton data may be image data including an image of one frame, or image data including images of a plurality of consecutive frames captured as a moving image at a plurality of different times. Note that, in the following description, an image of one frame may be referred to as a frame image or simply as a frame.

The unit action is defined based on at least a part of the body of the worker or the posture of the whole body of the worker. The posture of the worker relates to movement of the body done by the worker, for example, in order to perform steps specified in the work action. That is, the unit action of the worker indicates a predetermined set of actions performed by the worker, and is composed of skeleton data of the worker. The unit action is defined based on a relative relation between the joint points or the skeleton structures composing the above-described skeleton data. The skeleton data for specifying the unit action may be data corresponding to one frame or data corresponding to a plurality of frames.

The determination unit 12 determines whether or not the unit action matches a predetermined registration action. The predetermined registration action includes skeleton data which is pre-registered data for reference and which can be compared with the above-described unit action. The registration action may include the unit action. The registration action may be the same as the unit action. The registration action is generated from image data obtained by capturing a state in which a worker is in a predetermined reference posture or is performing a predetermined reference action.

The determination result output unit 13 outputs a result of the determination made by the determination unit 12. The result of the determination output by the determination result output unit 13 is, for example, a signal indicating that the unit action is similar to the predetermined registration action or that the unit action is not similar to the predetermined registration action. Alternatively, the determination result output unit 13 may output a degree of similarity itself. A destination to which the determination result output unit 13 outputs a result of the determination is, for example, a terminal of a process manager who manages processes performed by a worker. When the action evaluation system 10 is connected to a display apparatus (not shown), the determination result output unit 13 may output a result of the determination to the display apparatus.

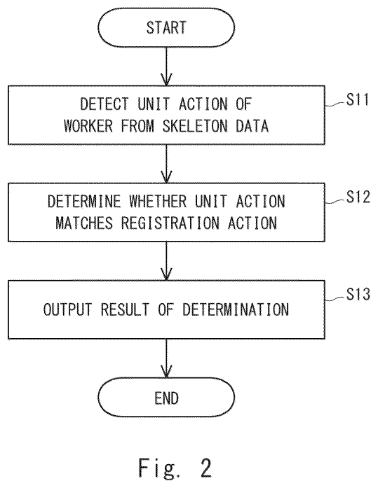

FIG. 2 is a flowchart showing an action evaluation method according to the first example embodiment. The flowchart shown in FIG. 2 is a processing method performed by the action evaluation system 10, and is started when, for example, the action evaluation system 10 receives skeleton data.

The analysis unit 11 detects a unit action associated with the posture of a worker from skeleton data about the structure of the body of the worker extracted from image data obtained by capturing a series of work actions performed by the worker on a work object (Step S11). The analysis unit 11 supplies a signal related to the detected unit action to the determination unit 12.

Next, the determination unit 12 determines whether or not the unit action matches a predetermined registration action by using the signal related to the unit action received from the analysis unit 11 (Step S12). The determination unit 12 supplies a result of the determination to the determination result output unit 13.

Then, when the determination result output unit 13 receives the result of the determination from the determination unit 12, it outputs the received result of the determination (Step S13). When the determination result output unit 13 outputs the result of the determination, the action evaluation system 10 ends the process.

The action evaluation system according to the first example embodiment has been described above. Note that the action evaluation system 10 includes a processor and a storage device as a configuration which is not shown. Examples of the storage device included in the action evaluation system 10 include a storage device including a non-volatile memory such as a flash memory or a Solid State Drive (SSD). In this case, the storage apparatus included in the action evaluation system 10 stores a computer program (hereinafter also referred to simply as a program) for executing the above-described image processing method. Further, the processor loads the computer program from the storage device into a buffer memory such as a Dynamic Random Access Memory (DRAM) and executes the loaded program.

Each of the components included in the action evaluation system 10 may be implemented by dedicated hardware. Further, some or all of the components may be implemented by general-purpose or dedicated circuitry, a processor, or the like, or a combination thereof. These components may be formed by a single chip or by a plurality of chips connected to each other through a bus. Some or all of the components of each apparatus may be implemented by a combination of the above-described circuitry or the like and a program. Further, a Central Processing Unit (CPU), a Graphics Processing Unit (GPU), a field-programmable gate array (FPGA), or the like may be used as the processor. Note that the descriptions about the configuration described here may also be applied to other apparatuses or systems described below in the present disclosure.

Further, when some or all of the components of the action evaluation system 10 are implemented by a plurality of information processing apparatuses, circuits, or the like, the plurality of information processing apparatuses, circuits, or the like may be disposed in one place in a centralized manner or arranged in a discrete manner. For example, the information processing apparatuses, the circuits, or the like may be implemented in the form of a client server system, a cloud computing system, or the like in which the information processing apparatuses, the circuits, or the like are connected to each other through a communication network. Further, the functions of the action evaluation system may be provided in the form of Software as a Service (Saas).

According to the present embodiment, it is possible to provide an action evaluation system and the like for suitably evaluating whether or not work to be performed by a worker is properly performed.

### Second Example Embodiment

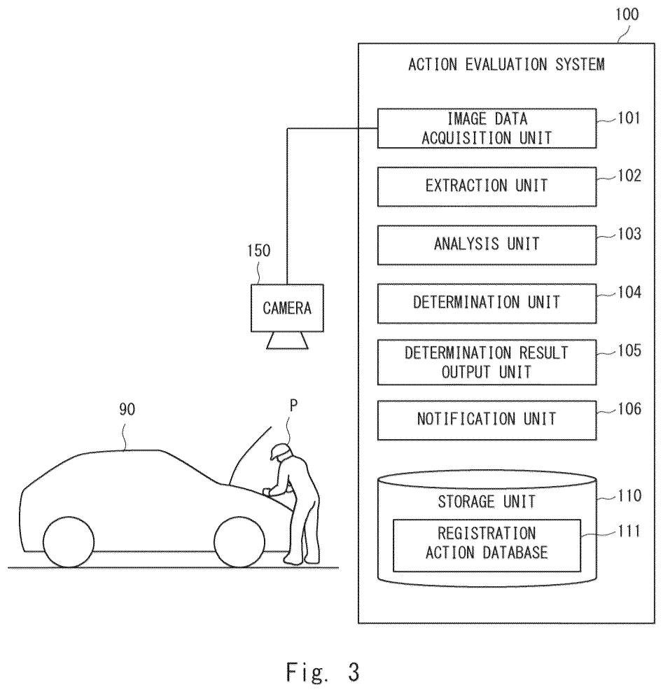

A second example embodiment of the present disclosure will be described. FIG. 3 is a diagram showing an overall configuration of an action evaluation system according to the second example embodiment. FIG. 3 includes an automobile 90, a worker P, an action evaluation system 100, and a camera 150.

The automobile 90 is one example embodiment of a work object. The automobile 90 described in this example embodiment is in a state in which an assembly process has been completed and an inspection process has started at an automobile manufacturing plant. In the inspection process, the automobile 90 is inspected by the worker P. In the inspection process, the worker P inspects the automobile 90 to determine whether or not it has a specified function or carries out a specified performance.

The camera 150 captures an image including a work action performed by the worker P in the inspection process of the automobile 90. The camera 150 captures an image each predetermined period, generates image data for each of the captured images, and sequentially supplies the image data to the action evaluation system 100. The predetermined period is, for example, 1/15 second, 1/30 second, or 1/60 second. Although only one camera 150 is shown in FIG. 3, a plurality of cameras 150 may be used. Further, the camera 150 may be a camera that pans, tilts, or zooms.

The action evaluation system 100 receives image data from the camera 150 and evaluates the posture or the action of the worker P included in the received image data. The action evaluation system 100 includes, as its main configuration, an image data acquisition unit 101, an extraction unit 102, an analysis unit 103, a determination unit 104, a determination result output unit 105, a notification unit 106, and a storage unit 110.

The image data acquisition unit 101 is connected to the camera 150 so that they communicate with each other and acquires image data from the camera 150. The image data acquired by the image data acquisition unit 101 includes an image obtained by capturing the work action performed by the worker P during the inspection process of the automobile 90. The image data acquired by the image data acquisition unit 101 includes an image captured by the camera 150 each predetermined period.

The extraction unit 102 extracts skeleton data from the image data. More specifically, the extraction unit 102 detects an image area of the body of a person (a body area) from a frame image included in the image data and extracts (e.g., cuts out) it as a body image. Then the extraction unit 102 extracts skeleton data about at least a part of the body of the person based on the features of the person such as the joints recognized in the body image by using a skeleton estimation technique using machine learning. The skeleton data is information including “key points”, which are characteristic points such as the joints, and “bone links”, which indicate links between the key points. The extraction unit 102 may use a skeleton estimation technique such as OpenPose. Note that, in the present disclosure, the aforementioned bone link may be referred to simply as a “bone”. The bone means a pseudo skeleton.

The analysis unit 103 detects a predetermined unit action associated with the posture of a worker from the extracted skeleton data of the worker. When the analysis unit 103 detects a unit action, the analysis unit 103 retrieves a registration action registered in a registration action database 111. Then, when skeleton data of the worker is similar to skeleton data related to the registration action, the analysis unit 103 recognizes the skeleton data as the unit action. That is, when the analysis unit 103 detects the registration action similar to skeleton data of the worker, the analysis unit 103 associates an action related to the skeleton data with the registration action and recognizes it as the unit action.

In the above-described determination as to the similarity, the analysis unit 103 detects a unit action by calculating the degree of similarity between forms of elements composing the skeleton data. A pseudo joint point or skeleton structure for indicating the body posture is set in skeleton data as its component. It can be said that, when one key point or bone is used as a reference, the form of the elements composing skeleton data is, for example, a relative geometric relation between the one key point or bone and another key point or bone, such as a position, a distance, an angle, and the like thereof. Alternatively, it can be said that the form of the elements composing skeleton data is, for example, a unified form formed by a plurality of key points and bones.

The analysis unit 103 analyzes whether or not the above relative forms of the components are similar to each other regarding two pieces of skeleton data to be compared with each other. At this time, the analysis unit 103 calculates the degree of similarity between two pieces of skeleton data. When the analysis unit 103 calculates the degree of similarity, the analysis unit 103 may calculate the degree of similarity by, for example, a feature value calculated from the components of skeleton data.

Note that, instead of the above degree of similarity, an object to be calculated by the analysis unit 103 may be the degree of similarity between a part of the extracted skeleton data and the skeleton data related to the registration action, the degree of similarity between the extracted skeleton data and a part of the skeleton data related to the registration action, or the degree of similarity between a part of the extracted skeleton data and a part of the skeleton data related to the registration action.

Note that the analysis unit 103 may calculate the above degree of similarity by directly or indirectly using the skeleton data. For example, the analysis unit 103 may convert at least a part of the skeleton data into another format and calculate the above degree of similarity using the converted data. In this case, the degree of similarity may be a degree of similarity itself between pieces of the converted data or a value calculated using the degree of similarity between the pieces of the converted data.

The conversion method may be normalization of an image size for the skeleton data or conversion into feature values using angles (i.e., the degrees of the bending of the joints) formed by the skeleton structure. Alternatively, the conversion method may be conversion into a three-dimensional posture performed by a machine learning model that has been trained in advance.

Note that the analysis unit 103 may detect a unit action from skeleton data extracted from one image data. Further, the analysis unit 103 may analyze the time-series work actions of the workers from the skeleton data extracted from each of a plurality of image data captured at a plurality of different times. By this configuration, the action evaluation system 100 can flexibly analyze an action so as to correspond to a state of change in a unit action to be detected.

The analysis unit 103 may detect a plurality of unit actions at a plurality of different times from a series of work actions. In this case, the determination unit 104 determines whether or not the series of work actions includes a unit action similar to each of a plurality of registration actions different from each other. By this configuration, the action evaluation system 100 can suitably analyze an action in which a plurality of types of movements are allowed to be randomly performed.

The analysis unit 103 may acquire an order in which a plurality of unit actions are detected. Further, in this case, the determination unit 104 determines whether or not a plurality of unit actions included in a series of work actions are detected in a predetermined order. By this configuration, the action evaluation system 100 can suitably analyze that the actions are performed according to a procedure.

In addition to the functions described above, the analysis unit 103 may specify a person present in a predetermined area of image data as the worker P. In this case, the analysis unit 103 sets a predetermined area in image data captured by the camera 150 and specifies a person present in the set area. More specifically, for example, the analysis unit 103 sets a rectangular area in the acquired image, and specifies a person whose feet are included in the set rectangular area as the worker P. By this configuration, the action evaluation system 100 can efficiently perform action analysis on an image including a person who is not a person to be analyzed.

Further, the analysis unit 103 may start the analysis of a series of work actions when the worker P enters a predetermined area from an area other than the predetermined area. That is, the analysis unit 103 can efficiently start the analysis of work actions by using as a trigger the fact that the worker P enters a work area where the worker P performs a series of work actions. Further, the analysis unit 103 may end the analysis of work actions when the worker P moves from the predetermined area to an area other than the predetermined area. That is, the analysis unit 103 can end the analysis of work actions by using as a trigger the fact that the worker P leaves the work area where the worker P performs a series of work actions. Note that, in the above-described case, the analysis unit 103 may start the analysis of work actions when the worker P moves from a predetermined area to an area other than the predetermined area, while the analysis unit 103 may end the analysis of work actions when the worker P enters a predetermined area from an area other than the predetermined area.

The determination unit 104 determines whether or not the unit action detected by the analysis unit 103 matches a predetermined registration action included in the registration action database 111. The registration action is data registered in advance as a sample of a standard action performed in a work action. The registration action is indicated by skeleton data. Data about registration actions is included in the registration action database.

The determination unit 104 may determine whether or not the skeleton data of the worker related to the detected unit action is similar to the skeleton data as the registration action. That is, in this case, the action evaluation system 100 determines a correspondence relationship when the degree of similarity between the skeleton data of the unit action and the skeleton data of the registration action is higher than a predetermined threshold while allowing that these pieces of skeleton data are not the same. By this configuration, the action evaluation system 100 can suitably determine an action including an ambiguous part.

The determination result output unit 105 outputs a result of the determination made by determination means. The result of the determination output by the determination result output unit 105 is, for example, a signal indicating that the unit action matches the predetermined registration action or that the unit action does not match the predetermined registration action. The determination result output unit 105 supplies a signal related to the result of the determination to the notification unit 106.

The notification unit 106 is means for sending a notification of information about a result of the determination as to the work performed by the worker P. The notification unit 106 includes a speaker for sending a notification about a result of the determination, for example, by voice. In this case, the notification unit 106 outputs an alert voice alerting the worker P in accordance with the signal of a result of the determination received from the determination result output unit 105.

In a first example in which the notification unit 106 outputs an alert voice, the unit action related to the work action performed by the worker P does not match the registration action. In this example, standard work to be performed by the worker P is registered in the registration action.

In a second example in which the notification unit 106 outputs an alert voice, the unit action related to the work action performed by the worker P matches the registration action. In this example, a registration action as work which the worker P should not perform is registered.

In a third example in which the notification unit 106 outputs an alert voice, a part of the unit action related to the work action performed by the worker P does not match a part of the registration action. In this example, a series of work actions performed by the worker P is composed of a plurality of unit actions, and the registration action includes a plurality of actions.

In a fourth example in which the notification unit 106 outputs an alert voice, the unit action related to the work action performed by the worker P are not performed in a predetermined order. In this example, a series of work actions performed by the worker P are a plurality of unit actions, and are composed in a predetermined order, and a plurality of actions are registered in a predetermined order as a series of work actions.

Note that the notification unit 106 may include a lamp, a buzzer, a display, or the like in place of or in addition to the speaker.

The storage unit 110 is storage means including a non-volatile memory. The storage unit 110 stores at least the registration action database 111. The registration action database 111 includes skeleton data as a registration action. The registration action database 111 may also include data related to a work procedure when it includes a plurality of actions. Thus, the action evaluation system 100 can evaluate a series of work actions including a plurality of work steps.

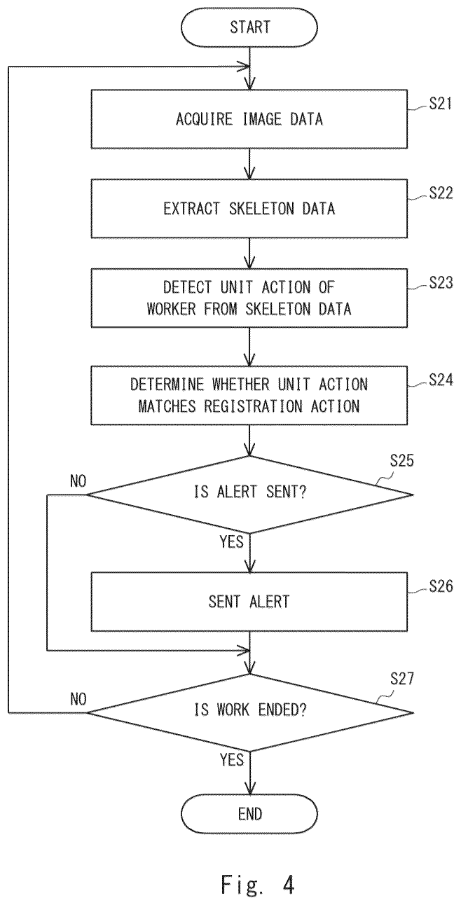

Next, processing performed by the action evaluation system 100 according to this example embodiment will be described with reference to FIG. 4. FIG. 4 is a flowchart showing an action evaluation method according to the second example embodiment. The action evaluation system 100 according to the flowchart shown in FIG. 4 evaluates a series of work actions including a plurality of unit actions.

First, the image data acquisition unit 101 acquires image data from the camera 150 (Step S21). The image data acquisition unit 101 supplies the acquired image data to the extraction unit 102.

Next, the extraction unit 102 cuts out an image of a worker from the received image data and extracts skeleton data from the cut-out image (Step S22). The extraction unit 102 supplies the extracted skeleton data to the analysis unit 103.

Next, the analysis unit 103 detects a unit action of the worker from the received skeleton data (Step S23). When the analysis unit 103 extracts the unit action, it supplies the extracted unit action to the determination unit 104.

Next, the determination unit 104 compares the received unit action with the registration action database 111 stored by the storage unit 110, and determines whether or not the unit action matches the registration action (Step S24). Further, the determination unit 104 supplies a result of the determination to the determination result output unit 105.

Next, the determination result output unit 105 determines whether or not to send an alert based on the result of the determination received from the determination unit 104 (Step S25). Note that a condition for sending an alert may be, for example, one of the above four conditions, or it may be any other condition. When the determination result output unit 105 determines to send an alert (Step S25: YES), the determination result output unit 105 supplies a signal instructing the notification unit 106 to send an alert. In this case, the notification unit 106 sends a predetermined alert to the worker P (Step S26) and proceeds to Step S27. On the other hand, when the determination result output unit 105 determines not to send an alert (Step S25: NO), the determination result output unit 105 skips Step S25 and proceeds to Step S27.

In Step S27, the action evaluation system 100 determines whether or not the work performed by the worker P is ended (Step S27). Specifically, for example, the action evaluation system 100 may determine that the work is ended by detecting a predetermined trigger. The predetermined trigger, for example, may be generated when an action performed by a worker includes an action indicating that work is ended, or when a predetermined operation performed by a worker is received. When the action evaluation system 100 does not determine that the work is ended (Step S27: NO), the action evaluation system 100 returns to Step S21 and continues the process. On the other hand, when the action evaluation system 100 determines that the work is ended (Step S27: YES), the action evaluation system 100 ends the process.

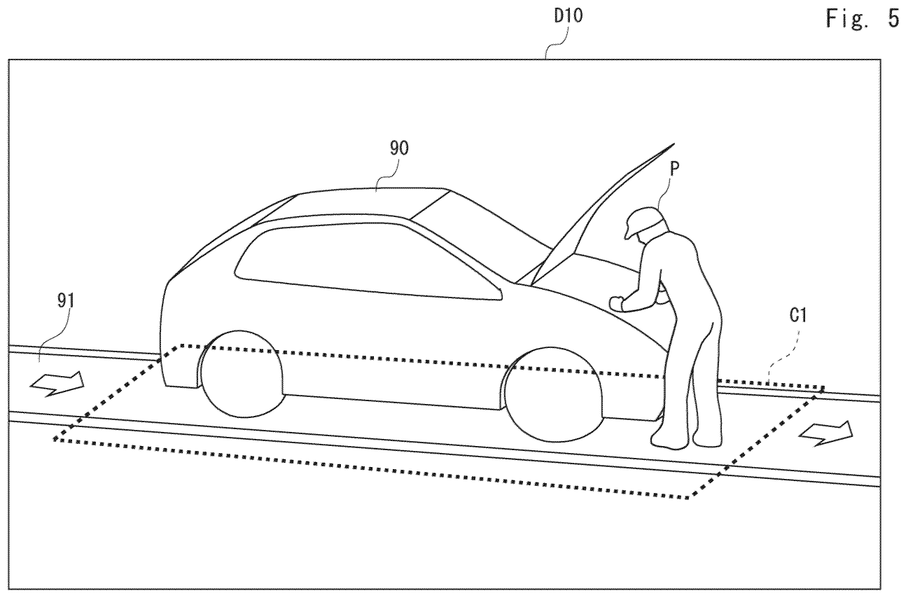

Next, an example of an image captured by the camera 150 will be described with reference to FIG. 5. FIG. 5 is a diagram showing an example of image data acquired by the action evaluation system. FIG. 5 shows an image D10 captured by the camera 150. The image D10 includes the worker P, the automobile 90, a conveyor 91, and a work area C1.

The worker P inspects the automobile 90 as a predetermined work action. The automobile 90 is an object on which the worker P performs work. The automobile 90 is in a state in which it is conveyed by the conveyor 91 from the left side of the image D10 and is stopped inside the work area C1. The conveyor 91 moves from the left side of FIG. 5 to the right side thereof in response to a predetermined operation, thereby conveying the automobile 90. The work area C1 is an area defined by the action evaluation system 100 and is shown by a thick dotted line in the image D10. The work area C1 shows a place specified as a place where the worker P inspects the automobile 90.

The worker P waits at a place that is a certain distance from the conveyor 91 before the automobile 90 is conveyed. When the automobile 90 is conveyed by the conveyor 91, the worker P enters the work area C1 and starts predetermined work. The camera 150 supplies image data generated by capturing the above-described state to the action evaluation system 100. When the action evaluation system 100 receives the image data from the camera 150, it starts analysis of the action of the worker P by using as a trigger the fact that the worker P enters the work area C1 shown in the image D10. Note that, for example, the automobile 90 may autonomously travel to enter the work area C1 instead of being conveyed by the conveyor 91. In this case, the worker P or another worker may drive the automobile 90 from a place where the process before the process performed in the work area C1 is performed, and stop the automobile 90 in the work area C1.

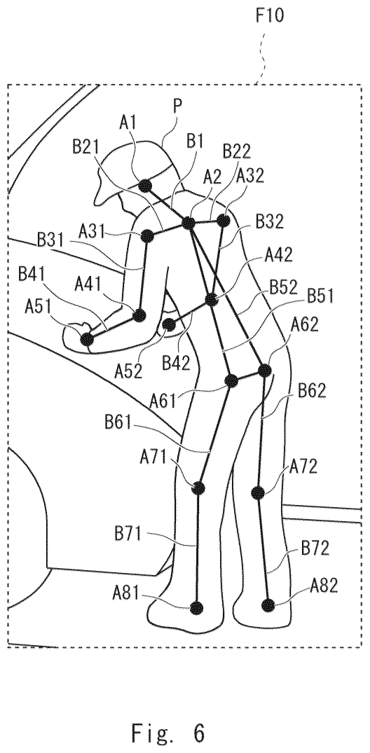

Next, an example of a case in which the posture of the worker P is detected will be described with reference to FIG. 6. FIG. 6 is a diagram showing skeleton data extracted from image data. The image shown in FIG. 6 is a body image F10 obtained by extracting the body of the worker P from the image shown in FIG. 5. In the action evaluation system 100, the extraction unit 102 cuts out the body image F10 from the image D10 shown in FIG. 5 and further sets a skeleton structure.

The extraction unit 102 extracts, for example, feature points that can be key points of a person from the image. The extraction unit 102 further detects key points from the extracted feature points. When the extraction unit 102 detects key points, it refers to, for example, information obtained by machine-learning the images of the key points.

In the example shown in FIG. 6, the extraction unit 102 detects, as the key points of the worker P, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82.

Further, the extraction unit 102 sets a bone connecting the above key points to each other as a pseudo skeleton structure of the worker P as shown below. A bone B1 connects the head A1 to the neck A2. A bone B21 connects the neck A2 to the right shoulder A31, and a bone B22 connects the neck A2 to the left shoulder A32. A bone B31 connects the right shoulder A31 to the right elbow A41, and a bone B32 connects the left shoulder A32 to the left elbow A42. A bone B41 connects the right elbow A41 to the right hand A51, and a bone B42 connects the left elbow A42 to the left hand A52. A bone B51 connects the neck A2 to the right waist A61, and a bone B52 connects the neck A2 to the left waist A62. A bone B61 connects the right waist A61 to the right knee A71, and a bone B62 connects the left waist A62 to the left knee A72. Further, a bone B71 connects the right knee A71 to the right foot A81, and a bone B72 connects the left knee A72 to the left foot A82. When the extraction unit 102 generates skeleton data about the above-described skeleton structure, it supplies the generated skeleton data to the analysis unit 103.

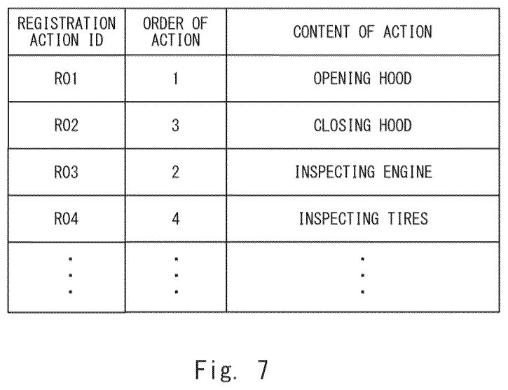

Next, an example of the registration action database 111 will be described with reference to FIG. 7. FIG. 7 is a table showing an example of the registration actions stored by the storage unit 110 according to the second example embodiment. In the table shown in FIG. 7, a registration action ID (identification, identifier), the order of the action, and the content of the action are associated with each other. The order of the action of the registration action ID (or the action ID) “R01” is “1”, and the content of the action is “opening a hood”. The order of the action of the registration action ID “R02” is “3”, and the content of the action is “closing a hood”. The order of the action of the registration action ID “R03” is “2”, and the content of the action is “inspecting an engine”. The order of the action of the registration action ID “R04” is “4”, and the content of the action is “inspecting tires”.

As described above, in data about the registration actions included in the registration action database 111, the action ID and the order of the action is added to each of the actions. Further, each registration action includes skeleton data. That is, for example, the registration action the action ID of which is “R01” includes skeleton data indicating an action of opening a hood.

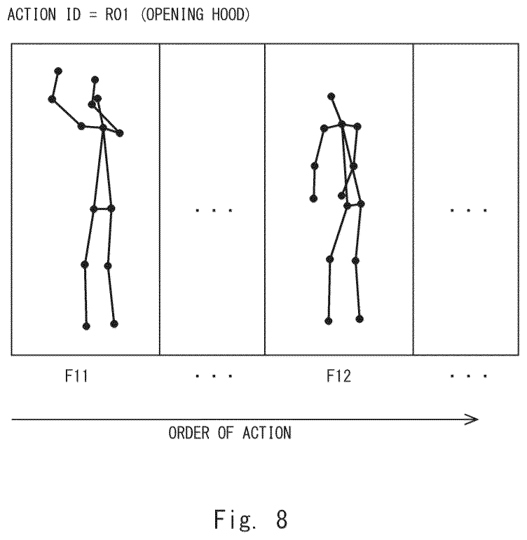

Skeleton data related to the registration action will be described with reference to FIG. 8. FIG. 8 is a diagram showing a first example of skeleton data in the registration action. FIG. 8 shows skeleton data about the action of the action ID “R01” shown in FIG. 7 among the registration actions included in the registration action database 111. FIG. 8 shows a plurality of pieces of skeleton data including skeleton data F11 and skeleton data F12 arranged in the left/right direction. The skeleton data F11 is shown on the left side with respect to the skeleton data F12. The skeleton data F11 indicates a posture of a person in which the person raises his/her arms while standing. The skeleton data F12 indicates a posture of a person in which the person lowers his/her arms while standing.

The above indications mean that, in the registration action of the action ID “R01”, a person takes the posture of the skeleton data F12 after he/she has taken the posture corresponding to the skeleton data F11. Note that, although two pieces of skeleton data have been described here, the registration action of the action ID “R01” may include skeleton data other than the above-described skeleton data.

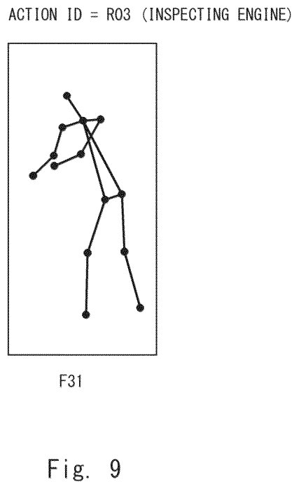

The skeleton data related to the registration action will be further described with reference to FIG. 9. FIG. 9 is a diagram showing a second example of skeleton data in the registration action. FIG. 9 shows skeleton data F31 about the action of the action ID “R03” shown in FIG. 7. For the registration action of the action ID “R03”, only the skeleton data F31 is registered.

As described above, the registration action may include only one skeleton data. The analysis unit 103 of the action evaluation system 100 compares the registration action including the above-described skeleton data with the skeleton data related to the unit action received from the extraction unit 102, and determines whether or not a similar registration action is present.

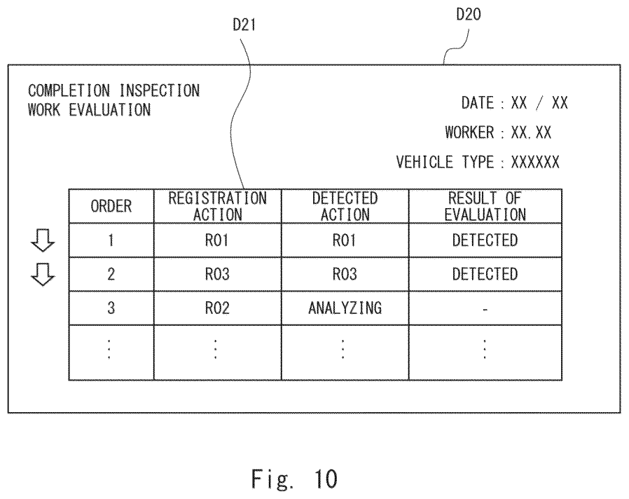

Next, an example of a result of determination output by the action evaluation system 100 will be described with reference to FIG. 10. An image D20 shown in FIG. 10 is an image in which a result of the determination output by the action evaluation system 100 is displayed on a predetermined display unit (not shown). The image D20 shows an evaluation status of inspection work of the automobile 90.

The image D20 shows information about the date of the work, the name of the worker (the attribute of the worker), and the vehicle type (the attribute of the automobile 90). Further, the image D20 includes a work evaluation display part D21. The work evaluation display part D21 displays information in which the work order, the action IDs of the registration actions, the action IDs of pieces of the detected work, and the results of the evaluation are associated with each other. In the order 1, the action ID of the registration action is R01, and the action ID of the detected unit action is R01. Since the registration action matches the detected action, “detected” is shown in the result of the evaluation. Similarly, in the order 2, the action ID of the registration action is R03, and the action ID of the detected unit action is R03. Since the registration action matches the detected action, “detected” is shown in the result of the evaluation. In the order 3, it is displayed that the action performed by the worker is being analyzed.

As described above, the action evaluation system 100 can sequentially analyze and evaluate the action performed by the worker P. When the registration action does not match the detected action, the action evaluation system 100 may display a notification of an alert in the image D20.

Although the second example embodiment has been described above, the action evaluation system 100 according to the second example embodiment is not limited to the configuration described above. For example, the camera 150 may include some or all of the functions of the extraction unit 102 included in the action evaluation system 100. In this case, for example, the camera 150 may extract a body image of a person by processing the captured image. Alternatively, the camera 150 may further extract from the body image skeleton data of at least a part of the body of a person based on features of the person such as the joints recognized in the body image. When the camera 150 performs the above functions, the camera 150 at least supplies the skeleton data to the action evaluation system 100. In addition to the skeleton data, the camera 150 may also supply image data to the action evaluation system 100. In addition to the configuration examples described above, the action evaluation system 100 may include the camera 150. Alternatively, the camera 150 may include some or all of the components of the action evaluation system 100. According to this example embodiment, it is possible to provide an action evaluation system, an action evaluation method, and the like for suitably evaluating whether or not work to be performed by a worker is properly performed.

### Third Example Embodiment

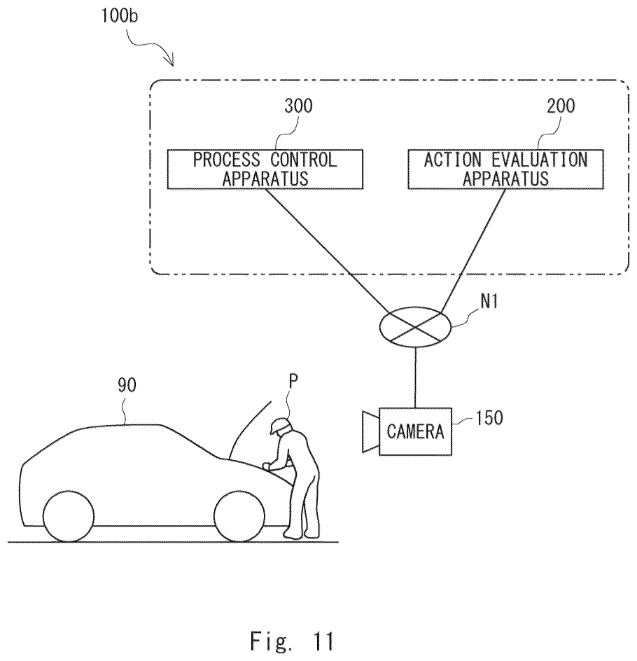

A third example embodiment of the present disclosure will be described. FIG. 11 is a diagram showing an overall configuration of an action evaluation system according to the third example embodiment. FIG. 11 shows the automobile 90, the worker P, the camera 150, and an action evaluation system 100b. The action evaluation system 100b includes an action evaluation apparatus 200 and a process control apparatus 300. The action evaluation apparatus 200 is connected to the process control apparatus 300 so that they communicate with each other through a network N1.

### (Action Evaluation Apparatus)

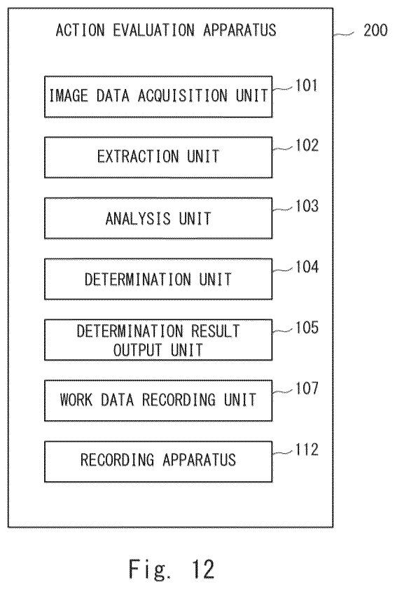

The action evaluation apparatus 200 will be described with reference to FIG. 12. FIG. 12 is a block diagram showing a configuration of the action evaluation apparatus according to the third example embodiment. The action evaluation apparatus 200 includes the image data acquisition unit 101, the extraction unit 102, the analysis unit 103, the determination unit 104, the determination result output unit 105, a work data recording unit 107, and a recording apparatus 112. The action evaluation apparatus 200 differs from the action evaluation system 100 according to the second example embodiment in that it includes the work data recording unit 107 and the recording apparatus 112.

The work data recording unit 107 causes the recording apparatus 112 to record at least a part of the image data acquired by the image data acquisition unit 101. More specifically, for example, the work data recording unit 107 receives a result of the determination from the determination result output unit 105, and causes the recording apparatus 112 to record the image data in accordance with a predetermined condition based on the result of the determination. The predetermined condition set here may be similar to, for example, the condition for sending an alert in the second example embodiment. Alternatively, the predetermined condition may be any other condition.

The recording apparatus 112 is a non-volatile recording apparatus, such as a Solid State Drive (SSD), a Hard Disk Drive (HDD), or a flash memory. The recording apparatus 112 records a work action image so that it is possible to reproduce the work action image, the work action image including at least the unit action for which a determination as to whether the unit action is similar to the registration action has been made. The work action image recorded by the recording apparatus 112 may include an image captured by the camera 150 or may include skeleton data extracted from the image data. The recording apparatus 112 may be configured integrally with the action evaluation apparatus 200 or may be physically removable from the action evaluation apparatus 200.

Note that the action evaluation apparatus 200 according to this example embodiment does not include the registration action database 111. However, the action evaluation apparatus 200 acquires data corresponding to the registration action database 111 from the process control apparatus 300 connected to the action evaluation apparatus 200 so that they can communicate with each other. Further, the action evaluation apparatus 200 can receive data corresponding to the registration action database 111 from the process control apparatus 300 in a timely manner when the content of the work performed by the worker P changes.

### (Process Control Apparatus)

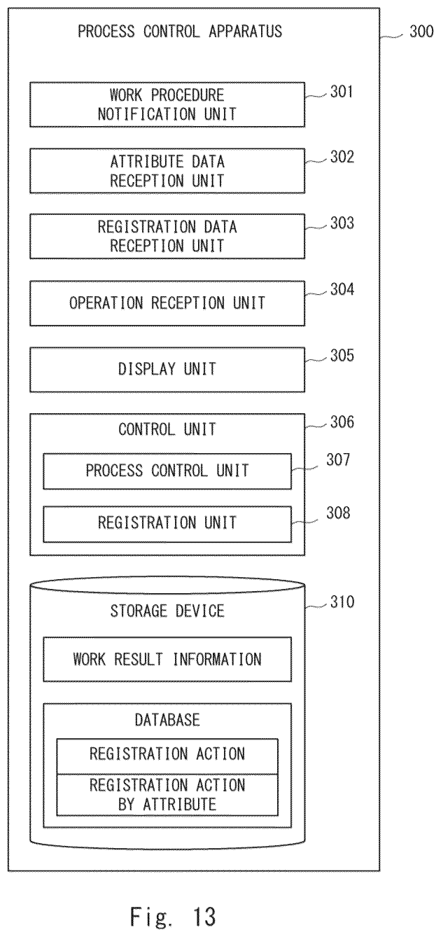

Next, the process control apparatus 300 will be described with reference to FIG. 13. FIG. 13 is a block diagram showing a configuration of the process control apparatus 300 according to the third example embodiment. The process control apparatus 300 includes, as its main configuration, a work procedure notification unit 301, an attribute data reception unit 302, a registration data reception unit 303, an operation reception unit 304, a display unit 305, a control unit 306, and a storage device 310. The process control apparatus 300 may be a dedicated apparatus having the above-described configuration, or may be, for example, a server, a personal computer, a tablet PC, or a smartphone.

The work procedure notification unit 301 sends work procedure data to the action evaluation apparatus 200. The work procedure is data including a registration action included in a series of work actions performed on the automobile 90 which is a work object and the order in which a plurality of registration actions are performed. The work procedure notification unit 301 sends the work procedure data when, for example, the attribute of the automobile 90 which is a work object of the work performed by the worker P is changed.

The attribute data reception unit 302 receives attribute data of a work object. The attribute data reception unit 302 according to this example embodiment receives as the attribute data of the automobile 90 which is the work object, for example, data indicating the type of the automobile 90, the name of the automobile 90, and the serial number or the lot number of the automobile 90. The attribute data reception unit 302 may receive attribute data, for example, from another apparatus that manages the manufacturing process of the automobile 90. Alternatively, the attribute data reception unit 302 may receive attribute data by reading data input by a user who uses the action evaluation apparatus 200. The attribute data reception unit 302 may have a function of recognizing the attribute of the automobile 90 from image data by further having a recognition function including functions of object recognition, character reading, and the like.

In the above-described case, the work procedure notification unit 301 supplies the work procedure corresponding to the attribute data received by the attribute data reception unit 302 to the action evaluation apparatus 200. Further, the determination unit 104 of the action evaluation apparatus 200 determines whether or not the unit action is similar to the registration action corresponding to the above-described attribute data.

By this configuration, the action evaluation system 100b can easily perform an action evaluation according to a work object when, for example, a plurality of different types of work objects are manufactured in the same manufacturing line. That is, the action evaluation system 100b can efficiently evaluate work performed by a worker.

In order to register a registration action, the registration data reception unit 303 receives image data for generating a registration action and data associated with the image data. The data associated with the image data includes, for example, data about the type or the name of the automobile 90 corresponding to the registration action and the order of the registration actions.

The operation reception unit 304 includes input means, such as a keyboard or a touch panel, and receives an operation from a user who operates the process control apparatus 300. The display unit 305 is a liquid crystal panel or a display including organic electroluminescence.

The control unit 306 includes a computation apparatus such as a Central Processing Unit (CPU) or a Micro Controller Unit (MCU), and controls each component of the process control apparatus 300. The operation reception unit 304 includes a process control unit 307 and a registration unit 308.

The process control unit 307 controls work processes performed by the worker P. More specifically, for example, the process control unit 307 recognizes the status of the work process performed by the worker P using various types of data stored in the storage device 310 and data appropriately acquired from another device related to the manufacturing process of the automobile 90. Further, the process control unit 307 controls the exchange of data between the process control apparatus 300 and the action evaluation apparatus 200 in accordance with the recognized work process. The registration unit 308 processes the data received by the registration data reception unit 303 and stores the registration action in the storage device 310 as appropriate.

The storage device 310 includes at least a non-volatile memory and stores work result information and a database. The work result information includes information including the progress of work processes or information about a result of the determination made by the action evaluation apparatus 200. The database includes registration actions corresponding to the registration action database 111. The database also includes a registration action by attribute which is a registration action associated with the attribute of a work object.

Although the process control apparatus 300 has been described above, the process control apparatus 300 may further include specification means for specifying a worker as an individual in addition to the above-described configuration. In this case, for example, the action evaluation system 100b recognizes that the worker P is a registered specific person, and performs processing using the registration action of the specific person. The determination unit 104 of the action evaluation apparatus 200 determines whether or not the unit action related to the specified individual is similar to a predetermined registration action related to the specified individual. Thus, the action evaluation system 100b can evaluate the work action by associating it with the individual.

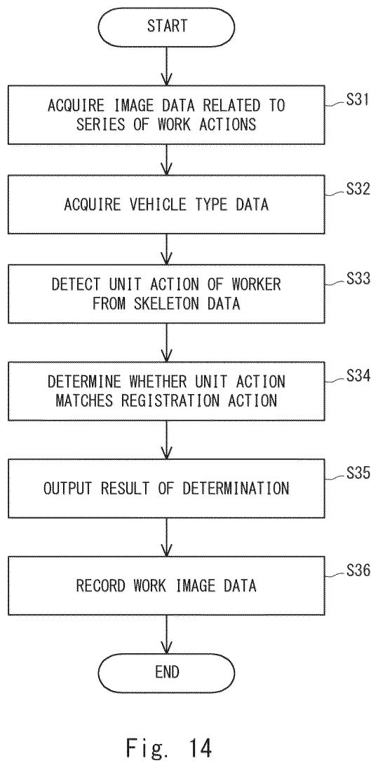

Next, processing performed by the action evaluation system 100b will be described. FIG. 14 is a flowchart showing an action evaluation method according to the third example embodiment.

First, the image data acquisition unit 101 of the action evaluation apparatus 200 acquires image data related to a series of work actions (Step S31). Here, the image data acquisition unit 101 may acquire images of a plurality of frames collectively.

Next, the process control apparatus 300 acquires vehicle type data (Step S32). The process control apparatus 300 supplies the received vehicle type data to the action evaluation apparatus 200.

Next, the action evaluation apparatus 200 extracts skeleton data from the acquired image data and detects the unit action of a worker from the extracted skeleton data (Step S33). Note that, when the action evaluation apparatus 200 detects the unit action, the registration action corresponding to the vehicle type data acquired by the process control apparatus 300 is used.

Next, the determination unit 104 of the action evaluation apparatus 200 determines whether or not the unit action matches the registration action (Step S34).

Next, the determination result output unit 105 outputs a result of the determination to the work data recording unit 107 (Step S35).

Next, the work data recording unit 107 records work image data (Step S36) and ends the process. Note that the action evaluation apparatus 200 supplies the stored work image data to the process control apparatus 300 as appropriate in response to a request from the process control apparatus 300.

The processing performed by the action evaluation system 100b has been described above. By performing the processing described above, the action evaluation system 100b can make a user recognize work performed by the worker P in a state in which the work can be analyzed after it is done. The user can objectively analyze the work performed by the worker P by using the recorded work image data. Therefore, the user is able to understand what the level of the proficiency of the worker P in the work is, and determine whether or not a work guidance should be given to the worker P. Alternatively, the user can use the work image data recorded as data for objectively evaluating work performed by the worker P.

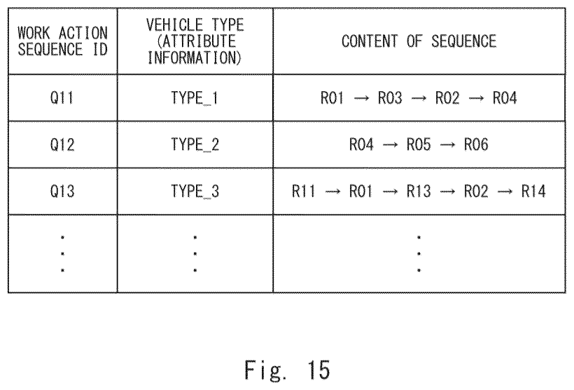

Next, an example of a work action stored in the action evaluation system 100b will be described with reference to FIG. 15. FIG. 15 is a table showing an example of a work action stored in the action evaluation system according to the third example embodiment. Table of FIG. 15 shows a work action sequence ID, data about a vehicle type as attribute information of the automobile 90, and the content of the sequence.

For example, in the work action of the work action ID “Q11”, the vehicle type corresponds to TYPE_1. Further, in the content of the sequence of the work action ID “Q11”, R01, R03, R02, and R04 are shown in this order using the action ID of the registration action stored separately by the action evaluation system 100b. Similarly, in the work action of the work action ID “Q12”, the vehicle type corresponds to TYPE_2, and in the content of the sequence, R04, R05, and R06 are shown in this order. In the work action of the work action ID “Q13”, the vehicle type corresponds to TYPE_3, and in the content of the sequence, R11, R01, R13, R02, and R14 are shown in this order.

As described above, the action evaluation system 100b associates data related to the vehicle type, which is the attribute data of the automobile 90 that is a work object, with the registration action, which is a series of work actions performed on each automobile 90, and stores a work action sequence for each vehicle type. By using this work action sequence, the action evaluation system 100b can suitably evaluate the action even when products of different types are manufactured in the same manufacturing line.

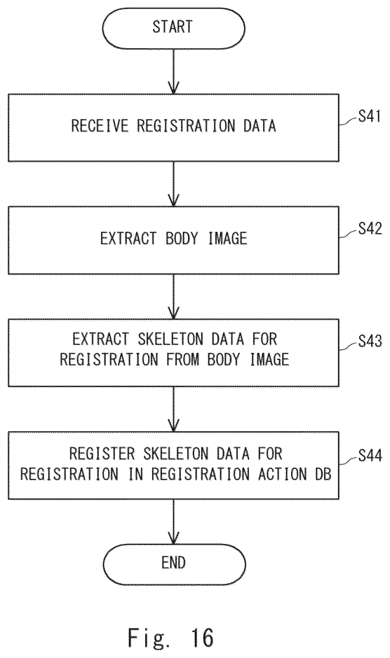

Next, an example of a case in which a registration action is registered will be described with reference to FIG. 16. FIG. 16 is a flowchart showing processing for registering a registration action according to the third example embodiment. The flowchart shown in FIG. 16 starts, for example, by instructing each component that the registration unit 308 registers the registration action. First, the image data acquisition unit 101 of the action evaluation apparatus 200 receives image data for registration from the camera 150 (Step S41). Note that the action evaluation system 100b may acquire image data from a camera for registration (not shown).

Next, the extraction unit 102 extracts a body image from the image data related to registration data (Step S42), and further extracts skeleton data for registration from the body image (Step S43). The extraction unit 102 supplies the extracted skeleton data to the registration data reception unit 303 of the process control apparatus 300.

Next, the process control unit 307 registers the registration data received by the registration data reception unit 303 in the registration database (Step S44), and ends a series of processes.

The third example embodiment has been described above. According to this example embodiment, it is possible to provide an action evaluation system and the like for suitably evaluating whether or not work to be performed by a worker is properly performed.

Note that although the present disclosure has been described as a hardware configuration in the above-described example embodiments, the present disclosure is not limited thereto. In the present disclosure, any processing can also be implemented by causing a processor to execute a computer program.

In the example described above, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (R0M), a flash memory, a solid-state drive (SSD) or other types of memory technologies, a CD-R0M, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

An action evaluation system comprising:
analysis means for detecting a predetermined unit action associated with a posture of a worker from skeleton data about a structure of a body of the worker, the skeleton data being extracted from image data obtained by capturing a series of work actions performed by the worker on a work object:
determination means for determining whether or not the unit action is similar to a predetermined registration action; and
determination result output means for outputting a result of the determination made by the determination means.

### (Supplementary Note 2)

The action evaluation system according to supplementary note 1, wherein the analysis means detects the unit action when the skeleton data related to the unit action is similar to the skeleton data as the registration action based on forms of elements composing the skeleton data.

### (Supplementary Note 3)

The action evaluation system according to supplementary note 1 or 2, wherein the analysis means analyzes the time-series work actions of the worker based on the skeleton data extracted from each of a plurality of image data captured at a plurality of different times.

### (Supplementary Note 4)

The action evaluation system according to any one of supplementary notes 1 to 3, wherein
the analysis means detects a plurality of the unit actions at a plurality of different times from the series of the work actions, and
the determination means determines whether or not the series of the work actions includes the unit action similar to each of a plurality of the registration actions different from each other.

### (Supplementary Note 5)

The action evaluation system according to supplementary note 4, wherein
the analysis means acquires an order in which the plurality of the unit actions are detected, and
the determination means determines whether or not the plurality of the unit actions included in the series of the work actions are detected in a predetermined order.

### (Supplementary Note 6)

The action evaluation system according to any one of supplementary notes 1 to 5, further comprising storage means for storing the registration action,
wherein when the analysis means detects the registration action similar to the skeleton data of the worker, the analysis means associates an action related to the skeleton data with the registration action and recognizes the associated action as the unit action.

### (Supplementary Note 7)

The action evaluation system according to any one of supplementary notes 1 to 6, further comprising:
image data acquisition means for acquiring the image data; and
extraction means for extracting the skeleton data from the image data.

### (Supplementary Note 8)

The action evaluation system according to supplementary note 7, wherein the analysis means specifies a person present in a predetermined area of the image data as the worker.

### (Supplementary Note 9)

The action evaluation system according to supplementary note 8, wherein the analysis means starts or ends the analysis of the series of the work actions when the worker enters the predetermined area from an area other than the predetermined area or when the worker moves from the predetermined area to an area other than the predetermined area.

### (Supplementary Note 10)

The action evaluation system according to any one of supplementary notes 1 to 9, further comprising an attribute data reception unit configured to receive attribute data about an attribute of the work object,
wherein the determination means determines whether or not the unit action is similar to the predetermined registration action corresponding to the attribute.

### (Supplementary Note 11)

The action evaluation system according to supplementary note 10, further comprising a storage unit configured to associate the attribute data about the work object with the series of the work actions performed on the work object and store the associated data.

### (Supplementary Note 12)

The action evaluation system according to any one of supplementary notes 1 to 11, further comprising recording means for recording a work action image so that it is possible to reproduce the work action image, the work action image including at least the unit action for which a determination as to whether or not the unit action is similar to the registration action has been made.

### (Supplementary Note 13)

The action evaluation system according to any one of supplementary notes 1 and 12, further comprising specification means for specifying the worker as an individual,
wherein the determination means determines whether or not the unit action related to the specified individual is similar to the predetermined registration action related to the specified individual.

### (Supplementary Note 14)

An action evaluation method performed by a computer, the action evaluation method comprising:
detecting a predetermined unit action associated with a posture of a worker from skeleton data about a structure of a body of the worker extracted from image data obtained by capturing a series of work actions performed by the worker on a work object;
determining whether or not the unit action is similar to a predetermined registration action; and
outputting a result of the determination.

### (Supplementary Note 15)

A non-transitory computer readable medium storing a program for causing a computer to perform an action evaluation method comprising:
detecting a predetermined unit action associated with a posture of a worker from skeleton data about a structure of a body of the worker extracted from image data obtained by capturing a series of work actions performed by the worker on a work object;
determining whether or not the unit action is similar to a predetermined registration action; and
outputting a result of the determination.

### REFERENCE SIGNS LIST

10 ACTION EVALUATION SYSTEM
11 ANALYSIS UNIT
12 DETERMINATION UNIT
13 DETERMINATION RESULT OUTPUT UNIT
90 AUTOMOBILE
91 CONVEYOR
100 ACTION EVALUATION SYSTEM
101 IMAGE DATA ACQUISITION UNIT
102 EXTRACTION UNIT
103 ANALYSIS UNIT
104 DETERMINATION UNIT
105 DETERMINATION RESULT OUTPUT UNIT
106 NOTIFICATION UNIT
107 WORK DATA RECORDING UNIT
110 STORAGE UNIT
111 REGISTRATION ACTION DATABASE
112 RECORDING APPARATUS
150 CAMERA
200 ACTION EVALUATION APPARATUS
300 PROCESS CONTROL APPARATUS
301 WORK PROCEDURE NOTIFICATION UNIT
302 ATTRIBUTE DATA RECEPTION UNIT
303 REGISTRATION DATA RECEPTION UNIT
304 OPERATION RECEPTION UNIT
305 DISPLAY UNIT
306 CONTROL UNIT
307 PROCESS CONTROL UNIT
308 REGISTRATION UNIT
310 STORAGE DEVICE
N1 NETWORK

What is claimed is:

1. An action evaluation system comprising:
at least one memory storing instructions, and
at least one processor configured to execute the instructions to;
detect a predetermined unit action associated with a posture of a worker from skeleton data about a structure of a body of the worker, the skeleton data being extracted from image data obtained by capturing a series of work actions performed by the worker on a work object;
determine whether or not the unit action is similar to a predetermined registration action; and
output a result of the determination.

2. The action evaluation system according to claim 1, wherein
the at least one processor is further configured to execute the instruction to detect the unit action when the skeleton data related to the unit action is similar to the skeleton data as the registration action based on forms of elements composing the skeleton data.

3. The action evaluation system according to claim 1, wherein
the at least one processor is further configured to execute the instruction to analyze the time-series work actions of the worker based on the skeleton data extracted from each of a plurality of image data captured at a plurality of different times.

4. The action evaluation system according to claim 1, wherein
the at least one processor is further configured to execute the instructions to detect a plurality of the unit actions at a plurality of different times from the series of the work actions, and
determine whether or not the series of the work actions includes the unit action similar to each of a plurality of the registration actions different from each other.

5. The action evaluation system according to claim 4, wherein
the at least one processor is further configured to execute the instructions to acquire an order in which the plurality of the unit actions are detected, and
determine whether or not the plurality of the unit actions included in the series of the work actions are detected in a predetermined order.

6. The action evaluation system according to claim 1, wherein
the at least one processor is further configured to execute the instructions to store the registration action, and
when the at least one processor detects the registration action similar to the skeleton data of the worker, associate an action related to the skeleton data with the registration action and recognizes the associated action as the unit action.

7. The action evaluation system according to claim 1, wherein
the at least one processor is further configured to execute the instructions to acquire the image data; and
extract the skeleton data from the image data.

8. The action evaluation system according to claim 7, wherein
the at least one processor is further configured to execute the instruction to specify a person present in a predetermined area of the image data as the worker.

9. The action evaluation system according to claim 8, wherein
the at least one processor is further configured to execute the instruction to start or end the analysis of the series of the work actions when the worker enters the predetermined area from an area other than the predetermined area or when the worker moves from the predetermined area to an area other than the predetermined area.

10. The action evaluation system according to claim 1, wherein
the at least one processor is further configured to execute the instruction to receive attribute data about an attribute of the work object,
wherein the at least one processor determines whether or not the unit action is similar to the predetermined registration action corresponding to the attribute.

11. The action evaluation system according to claim 10, wherein
the at least one processor is further configured to execute the instructions to associate the attribute data about the work object with the series of the work actions performed on the work object and store the associated data.

12. The action evaluation system according to claim 1, wherein
the at least one processor is further configured to execute the instruction to record a work action image so that it is possible to reproduce the work action image, the work action image including at least the unit action for which a determination as to whether or not the unit action is similar to the registration action has been made.

13. The action evaluation system according to claim 1, wherein
the at least one processor is further configured to execute the instructions to specify the worker as an individual,
wherein the at least one processor determines whether or not the unit action related to the specified individual is similar to the predetermined registration action related to the specified individual.

14. An action evaluation method performed by a computer, the action evaluation method comprising:
detecting a predetermined unit action associated with a posture of a worker from skeleton data about a structure of a body of the worker extracted from image data obtained by capturing a series of work actions performed by the worker on a work object;
determining whether or not the unit action is similar to a predetermined registration action; and
outputting a result of the determination.

15. A non-transitory computer readable medium storing a program for causing a computer to perform an action evaluation method comprising:
detecting a predetermined unit action associated with a posture of a worker from skeleton data about a structure of a body of the worker extracted from image data obtained by capturing a series of work actions performed by the worker on a work object;
determining whether or not the unit action is similar to a predetermined registration action; and
outputting a result of the determination.

16. The non-transitory computer readable medium according to claim 15, wherein the evaluation method further comprising;
detecting the unit action when the skeleton data related to the unit action is similar to the skeleton data as the registration action based on forms of elements composing the skeleton data.

17. The non-transitory computer readable medium according to claim 15, wherein the evaluation method further comprising;
analyzing the time-series work actions of the worker based on the skeleton data extracted from each of a plurality of image data captured at a plurality of different times.

18. The non-transitory computer readable medium according to claim 15, wherein the evaluation method further comprising;
detecting a plurality of the unit actions at a plurality of different times from the series of the work actions, and
determining whether or not the series of the work actions includes the unit action similar to each of a plurality of the registration actions different from each other.

19. The non-transitory computer readable medium according to claim 18, wherein the evaluation method further comprising;
acquiring an order in which the plurality of the unit actions are detected, and
determining whether or not the plurality of the unit actions included in the series of the work actions are detected in a predetermined order.

20. The non-transitory computer readable medium according to claim 15, wherein the evaluation method further comprising;
storing the registration action, and
when the computer detects the registration action similar to the skeleton data of the worker, associating an action related to the skeleton data with the registration action and recognizes the associated action as the unit action.
